(19) United States
(12) Patent Application Publication
(10) Pub. No.: US 2012/0306614 A1
(43) Pub. Date: Dec. 6, 2012

(54) SINGLE ELEMENT KEYLESS CONTROL SYSTEM

(75) Inventors: Peter Kaufman, Marquette, MI (US); Garrett Y. Kaufman, Carpinteria, CA (US)

(73) Assignee: ESSEX ELECTRONICS, INC.

(21) Appl. No.: 13/154,077

(22) Filed: Jun. 6, 2011

Related U.S. Application Data
(60) Provisional application No. 61/352,281, filed on Jun. 7, 2010.

(51) Int. Cl. G05B 19/00

(52) U.S. Cl. 340/5.28; 340/5.54; 340/5.31

(57) ABSTRACT

A single element keyless control system enabling a mechanism includes a switch that can be manipulated by a single finger between one “open” position and two “closed” positions. The system has multiple levels of security with higher security levels having longer access codes. The switch is spring biased to a central “open” position and may be easily moved to either “closed” position by a single finger. The user enters an access code manipulating the switch to a “closed” position consecutively a number of times equal to the digit being entered. The process is repeated for any remaining digits in the code. Upon entry of the correct access code, the user may then unlock or enable the mechanism using the same switch. The user may change the level of security. Visual feedback is included to indicate whether the system is enabled or not enabled, and to indicate the level of security.

### CROSS-REFERENCE TO RELATED APPLICATIONS

This application claims the benefit of U.S. Provisional Patent Application Ser. No. 61/352,281, filed Jun. 7, 2010, the entirety of which is incorporated by reference herein.

### BACKGROUND OF THE INVENTION

This invention pertains in general to keyless control or entry systems and, more particularly, to a single element keyless control system. The system of the present invention may be used in a variety of end uses such as an engine ignition system, such as motorcycle, jet ski or snowmobile applications, a residential door entry system, alarm systems, equipment control and the like. The present invention includes in one embodiment a single element switch adapted to be movable by a single finger between three positions, one “open” position and two “closed” positions.

The prior art includes electronic locking systems having a single switch. For example, U.S. Pat. No. 3,751,718, to Hanchett, teaches an electronic locking system utilizing a single two position switch. The primary disadvantage of the Hanchett system is that it requires the user to go through a series of ten cycles wherein each cycle lasts for about two seconds. The time required for a user to activate the mechanism of Hanchett is 20 seconds or more (presumably because a two position switch is used) and that amount of time makes the system undesirable and essentially commercially unfeasible.

U.S. Pat. No. 4,425,597 to Schramm teaches the use of the push button of an automobile door locking mechanism as the switch for entering a coded sequence within a specific period of time. The primary disadvantages of Schramm are, first, its teaching is limited to use of a common, two position door opening actuator as the switch and the description of its operation at column 8, lines 38-61, indicates that the timing circuit allows seven seconds to provide only sixteen possible combinations. The use of only sixteen possible combinations is woefully inadequate. For Schramm to provide a much larger number of combinations, considerably more than seven seconds would have to be consumed by the timing circuit for each attempt. These constraints seriously limit the usefulness of the Schramm system.

The prior art also includes keyless single switch systems such as U.S. Pat. No. 4,455,588 to Mochida, and U.S. Pat. No. 4,499,462 to Stoesser et al., both of which require a specified rhythmic sequence. The circuit arrangement senses the temporal intervals between the signals represented by the rhythm of a particular song, for example, and the sequencing of the various temporal intervals is used to determine the authorized code. The weakness of these systems is that the rhythmic sequences which are coded into those systems are highly individualistic. For example, if a husband programmed his specific rhythm for a portion of a song, it is highly unlikely that his wife or child would be able to enter the coded rhythm into the system.

The prior art also includes numerous keyless systems which include multiple buttons or elements, including U.S. Pat. No. 4,485,381 to Lewiner, U.S. Pat. No. 4,408,251 to Kaplan, U.S. Pat. No. 3,772,574 to Hughes and U.S. Pat. No. 3,633,167 to Hedin. One disadvantage of these systems is that a user may not be able to find both elements/buttons if, for example, it is dark, or the buttons/elements are hidden from view.

### SUMMARY OF THE PRESENT INVENTION

According to one aspect of the invention, a single element keyless control system having a single element switch that is pivotable by a single finger between three positions, including a central “open” position and two “closed” positions. Both “closed” positions are easily enabled with a single finger in order to enter an access code digit or digits and also may become the enabling/disabling switch for the device being controlled by the entry system such as a door lock, engine ignition, alarm system, etc. As used herein and in the claims, the word “open” is used in a broad sense to include a static or non-operative condition. According to this aspect of the present invention, the keyless control or entry system does not require the use of a specific rhythm and the access code may be entered either as quickly as the user can manipulate the switch or as slowly as the user desires, within reasonable time constraints.

According to another aspect of the present invention, a keyless control or entry system has multiple levels of security selectable by the user. Each higher security level's access code is a superset of a lower security level's access code. Multiple authorized users are able to quickly enter either a single access code or their own separate codes and a relatively large number of possible combinations is provided but wherein the access code may be entered relatively quickly.

### BRIEF DESCRIPTION OF THE DRAWINGS

FIG. 1 is a schematic representation of one embodiment of the single element keyless control system according to the present invention;

FIG. 2 is a plan view of the three way rocker switch of FIG. 1;

FIG. 3 is an elevational view of the three way rocker switch shown in FIGS. 1 and 2;

FIG. 4 is a schematic representation of an alternate embodiment of the single element keyless control system according to the present invention utilizing a push button switch;

FIG. 5 is a schematic representation of an alternate embodiment using a three position telescoping push button switch;

FIG. 6 is a schematic representation of a further embodiment using an alternate rocker switch;

FIG. 7 is a schematic representation of a further embodiment using a rotary switch; and

FIG. 8 is a schematic representation of a further embodiment using a piezoelectric element carried by a resiliently mounted button.

### DETAILED DESCRIPTION OF THE DRAWINGS

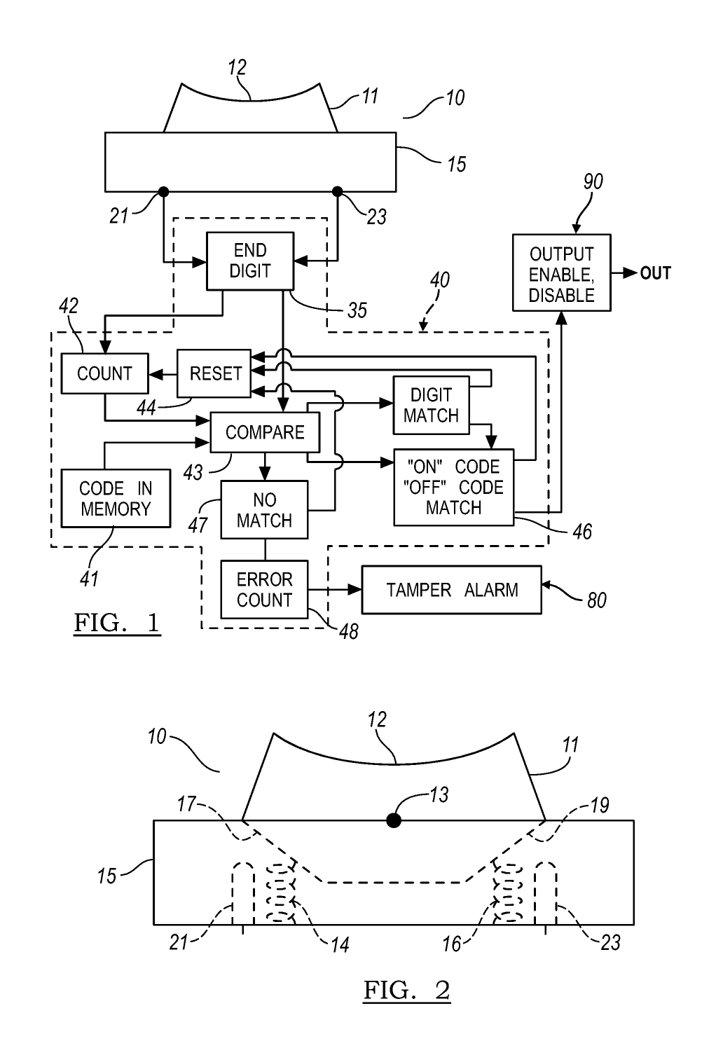

FIG. 1 shows a three position rocker switch shown generally as 10, a programmable microprocessor shown generally within the dotted lines 40, as well as a tamper alarm 80 and an output enable and disable circuit 90. Referring to FIG. 2, the three position rocker switch 10 comprises a button 11 and a housing 15. The housing 15 may be rectangular in nature having a central aperture in which the button 11 is located. The button 11 is concave on a top surface 12 so that a single finger may rest comfortably upon it and move the switch from one “closed” position to the other “closed” position.

The button 11 is pivotable around a pivot point 13 and is spring loaded. Two springs 14, 16 are located within the housing 15 and bias the button 11 into a central “open” position as seen in FIG. 2.

When a user's finger pivots the button 11 to one side, or to one of the “closed” positions, a lead 17, 19 contacts a stop 21, 23, causing an electrical signal to be generated. For example, looking at FIG. 2, if the finger pushes toward the left, spring 14 is compressed and lead 17 will contact stop 21 causing the signal to be sent from stop 21. Upon releasing the pressure, the spring 14 will return the button 11 to its “open” position thereby terminating the signal.

Access code entry is made by pressing the button 11 to one of the “closed” positions a number of times equal to the first digit of the access code. If the access code contains more than one digit, after the first digit has been entered, button 11 is then pushed to the other “closed” position and the next digit is entered. This is repeated until the full code has been entered.

The programmable microprocessor 40 shown in FIG. 1 includes an authorized access code of one or more digits which has been stored in memory, represented by box 41. A counter represented by box 42 counts the impulses as button 11 is depressed into one of the “closed” positions. When the button is pivoted to the other “closed” position, an end digit processor represented by box 35 signals that the digit has been completely input and activates the comparator 43.

For example, if the authorized access code is 711, the user would depress button 11 to one of the “closed” positions seven times, and counter 42 receives and counts these seven impulses. The user then would depress button 11 to its other “closed” position. Upon receiving a signal from the other “closed” position, the end digit 35 activates the comparator 43. At this point, the comparator 43 compares the “7” stored in the counter with the “7” stored in memory, notes the match and resets counter 42 through the reset represented by box 44. The single tap to the second “closed” position will then be counted by the counter 42 in order to enter the third digit. The user would then pivot the button 11 back to the first “closed” position, causing end digit 35 to enable comparator 43 again. The second match will be noted as well as the fact that only one digit remains to be entered.

For the last digit, comparator 43 makes a comparison after each user input is received. Thus, eliminating the need for a final pivot to signal the end of the last digit. So, in the example given above, the final pivot to the first “closed” position would complete the entry of the correct access code.

When the authorized access code is entered, an enable signal is transmitted through the code match system represented by block 46 and an enable signal is sent to the output, enable and disable circuit 90. If the end use is an engine ignition, for example, one of the closed positions of button 11 labeled “start” would utilize a push and hold circuit and would use mechanical contacts sufficient to energize the starter motor until the engine has started, at which point the user would release button 11.

The keyless entry system shown in FIG. 1 has a tamper alarm 80 which may be energized upon the occurrence of any predetermined number of erroneous access codes. For example, if only a single erroneous access code is entered, the “no match” is recorded by the “no match” circuitry, the counter is reset and the user is allowed to enter a code again. However, if an erroneous code is entered, for example, two times in a row, an error counter 48 notes that occurrence and energizes the tamper alarm 80. Tamper alarm 80 may be energized upon the occurrence of any predetermined number or sequence of erroneous code entries.

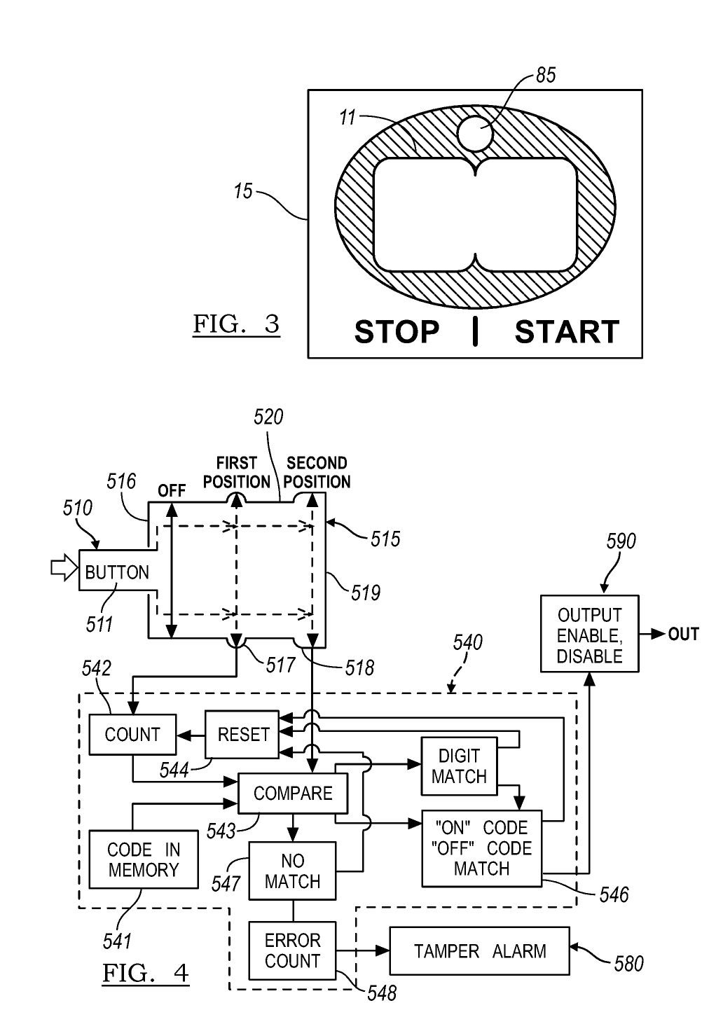

In an alternative embodiment, shown in FIG. 3, a tri-colored LED 85 may be provided which could, for example, blink green when the proper access code has been entered. Tri-colored LED 85 is one form of feedback means that may be used to indicate to the user whether the system is enabled or not enabled (armed). Other feedback options are lights, or audible or tactile feed-back. The LED 85 may also blink more rapidly when the tamper alarm has been activated. After the tamper alarm is energized, the system will not accept a user input for a predetermined period. Once the period has elapsed, the LED 85 will return to a slow blink indicating that input will be accepted again. The LED 85 may also begin to blink more rapidly once any user input has been received.

The system may also have various access codes of different lengths from which a user may select. Each access code length represents a different security level. A user may select the desired security level after an access code has been correctly entered by again depressing the button 11. Each successive actuation of the button 11 will alter the security level, consequently changing the access code.

In one embodiment, the control system has three levels of security including no security, low security and high security. The no security level does not require an access code. The low security level requires an access code having for example from one to three digits and the high security level uses an access code having for example from four to ten digits. The system is “disabled” when it must have an access code entered to become enabled. The system, after being enabled, ordinarily requires the user to make one further manipulation to start an engine, in the interest of safety. It is preferable for the low security access code to be a subset of the high security access code. For example, if the low security code is 1-2-3, the high security code may be 1-2-3-2-1.

Therefore, a user will only have to remember one code.

When a user enters the proper access code, the security level will automatically be set to no security. At this point, the user may either start or stop the device by rotating the button 11 in the appropriate direction as seen in FIG. 3. After the device has been stopped or disabled, the security level may be changed. Pressing the button 11 to the stop side once more will change the security to low level. Pressing the button to the stop side another time will change the security level to high security. Pressing the button to the stop side a third time will return the system to no security. Pressing the button towards the stop side again will change the security level to low security. Each subsequent depression of the button to the stop side will change the security level in this sequence. Feedback means such as tri-colored LED 85 preferably provides different feedback to the user representing each different level security. For example, no security may be indicated by LED 85 blinking green, low security blinking yellow, and high security blinking red. Other forms of feedback, such as audible or tactile feedback may also be provided.

In another embodiment, the selected security level's access code will be placed into memory 41 five seconds after the button 11 is last depressed. Thus, the security level can be changed again within 5 seconds before the system is armed with the selected security level. In the no security level, there should be no waiting period.

The tricolored LED 85 may display green when the control system is in the no security mode, amber for low security and red for high security. When the low or high security level is first selected by the user, the corresponding color is steadily emitted for the 5 second period. After 5 seconds, the LED begins a slow pulse to show that the access code for the selected security level now is required to be input in order to start the engine or enable the device.

In another embodiment, the control system has a sleep mode in which the device powers down to save electricity. The device powers down when no inputs have been received for a predetermined amount of time. The LED 85 is also then extinguished. After the system receives user input, the device powers back up and the LED resumes blinking the color corresponding to the security level the device was in before it entered sleep mode. The initial user input received when the system is in sleep mode is not counted by the counter 42.

In another embodiment, the system has a timer which records the duration between successive inputs. If no input is received for 5 seconds, the timer calls the reset 44 to reset the counter 42 and the LED 85 resumes its slower pulse. Consequently, the user must reenter the code from the beginning

In another embodiment, the user may program the access codes by for example depressing a program button (not shown) for 5 seconds. The LED 85 will then rapidly blink red and green alternatively. The user inputs the desired access code in the manner previously described. After a timer indicates 5 seconds have elapsed, the new code will replace the code in memory 41. If the new code is only 1-3 digits, it will replace the low security code and the system can only be armed into the low or no security. If the new code has, for example, more than 3 digits, the system can be armed into either no, low, or high security. If no input is received, after the program button is depressed and held for 5 seconds, the security features of the system are temporarily disabled until an access code is programmed. If the system has not been programmed, it will function as a normal unsecured on/off or start/stop switch.

In another preferred embodiment, individual users are assigned their own access codes. Rather than having one access code stored in memory 41, multiple access codes are stored in the memory 41. As a result of the multiple access codes, the comparator 43 compares the digit stored in the counter 42 with each code in memory 41 and notes each code with a matching first digit. When the second digit is compared, only those codes with the matching first digits are compared. The process is repeated, eliminating all non-matching access codes until a complete match is found and the processor then acts in the manner described above.

FIG. 4 shows a three position push button switch shown generally as 510, a programmable microprocessor shown generally within the dotted lines 540, as well as a tamper alarm 580 and an output enable and disable circuit 590. The three position push button switch 510 comprises a button 511 and a housing 515. The housing 515 may be cylindrical in nature and includes a proximal wall 516, a first detent 517, a second detent 518, and a rear wall 519. Detents 517 and 518 are raised portions of the cylindrical side wall 520 of housing 515 which provide the two “closed” positions for the three position push button switch 510. The proximal wall 516 is a flat wall through which push button 511 extends. Button 511 is spring loaded against rear wall 519 and in its rest position the button lies against proximal wall 516. This represents the “open” position of the three position switch 510.

Button 511 may carry spring loaded levers (not shown) which extend into detents 517 and 518. When the levers extend into detents 517, button 511 is in its first “closed” position and tactile feedback may be provided to the user. Code entry is made by pressing the button 511 to its first position a number of times equal to the first digit of the entry code. Since the first “closed” position is used only to enter pulses, it may consist of piezoelectric sensing elements, force sensing resistor elements, conductive elastomer or mechanical contacts. When the first digit has been entered, button 511 is then pushed fully to its second position wherein the end of that digit is recognized by the logic circuitry described below. This is repeated until the full code has been entered, if the access code contains more than one digit.

The programmable microprocessor 540 shown in FIG. 4 includes an authorized access code of one or more digits which has been stored in memory, represented by box 541. A counter represented by box 542 counts the impulses as button 511 is depressed into its first position represented by detent 517. For example, if the authorized access code is 711, the user would depress button 511 to its first “closed” position seven times, and counter 542 receives and counts these seven impulses. The user then depresses button 511 to its second “closed” position represented by detent 518.

At this point, the comparator represented by box 543 compares the “7” stored in the counter with the “7” stored in memory, notes the match and resets counter 542 through the reset represented by box 544. The same sequence is repeated for the second and third digits of the code. If the authorized access code is entered, an enable signal is transmitted through the code match system represented by block 546 and an enable signal is sent to the output, enable and disable circuit 590. If the end use is an engine ignition, for example, the second “closed” position of button 511 would utilize a push and hold circuit and would use mechanical contacts sufficient to energize the starter motor until the engine has started, at which point the user would release button 511.

Keyless entry system shown in FIG. 4 has a tamper alarm 580 which may be energized upon the occurrence of any predetermined number of erroneous access codes. For example, if only a single erroneous access code is entered, the “no match” is recorded by the “no match” circuitry, the counter is reset and the user is allowed to enter a code again. However, if an erroneous code is entered, for example, two times in a row, an error counter 548 notes that occurrence and energizes the tamper alarm 580. Tamper alarm 580 may be energized upon the occurrence of any predetermined number or sequence of erroneous code entries.

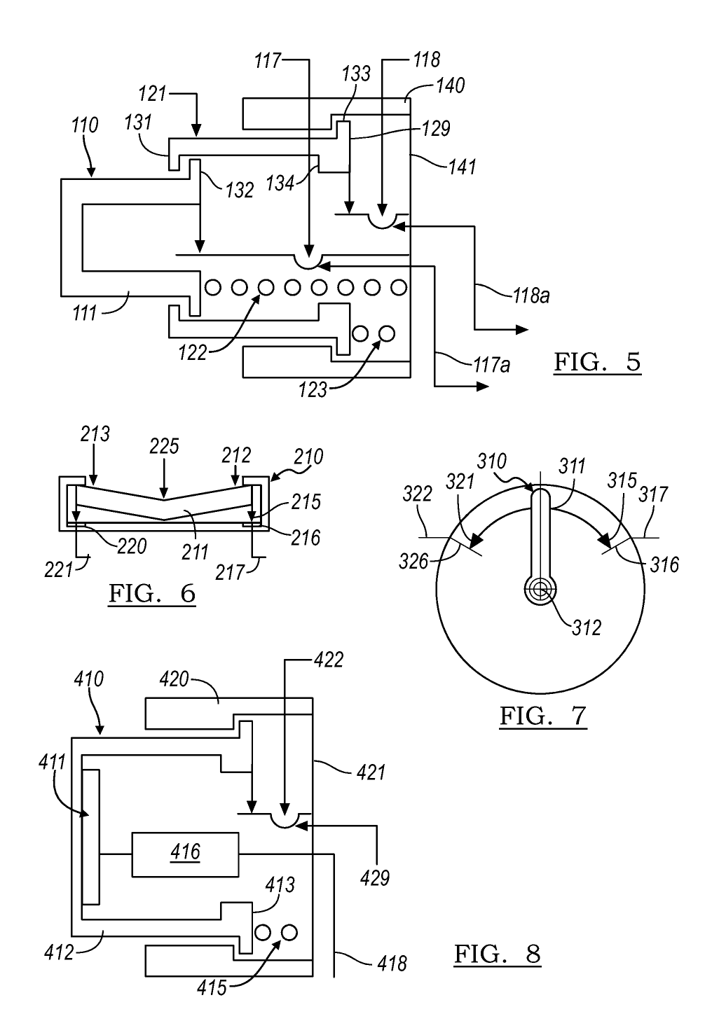

FIG. 5 shows an alternate three position push button switch shown generally as 110. This alternate embodiment shown in FIG. 5 is a telescoping variation of the push button switch 10 shown in FIG. 4. Button 111 is carried by an intermediate cylindrical portion 121. Button 111 is spring loaded by spring 122 which extends to rear wall 141. The intermediate section 121 is spring loaded by a second spring 123. Springs 122 and 123 extend around the base 132 of button 111 and the base 129 of intermediate section 121, respectively, but only the lower portions of those springs are shown in FIG. 5 for clarity. When the user depresses button 111, button 111 depresses spring 122 and, when the base 132 of button 111 reaches the detent 117, it is in its first “closed” position. To reach the second “closed” position 118, the user simply depresses button 111 beyond the first “closed” position 117, whereupon spring 123 is compressed and, when the base 129 of intermediate section 121 reaches detent 118, the switch 110 is in its second “closed” position. When switch 110 is in its first “closed” position, pulses are entered in identical fashion as with the push button switch shown in FIG. 4 with the pulses traveling down pathway 117a to the counter 542 (shown in FIG. 4). When the switch 110 is depressed fully into its second “closed” position 118, the input travels down pathway 118a to the comparator 543 (FIG. 4) and to the output, enable and disable circuit 590 (FIG. 4). The alternate form of the three position push button switch 110 shown in FIG. 5 provides tactile feedback to the user in similar fashion to the variation shown in FIG. 4.

The switch 110 includes three telescoping sections including the button, itself, 111, cylindrical intermediate section 121 and base section 140. Section 121 has a circular flange 131 extending inwardly at its proximal end which engages an outwardly extending flange 132 carried by the base of button 111. The distal or base end of intermediate section 121 has a peripheral flange 133 extending outwardly which engages the base portion 140. Intermediate section 121 has a shoulder 134 against which the base flange 132 of button 111 seats when button 111 is in its first “closed” position 117. As button 111 is pushed from its first “closed” position 117 to the second “closed” position 118, the base 132 of button 111 bears against shoulder 134 and causes the intermediate section 121 to depress the spring 123 until the base 129 of section 121 engages detent 118 in the second “closed” position 118.

With respect to the embodiments shown in FIGS. 4, 5 and 8, it is to be understood that, if the user releases the button after entering an intended code digit, for example a “7,” and then presses the button through the first “closed” position to the second “closed” position, the counter will be advanced to an “8.” To avoid errors caused in this manner, the logic circuitry for these type switches will simply delete one of the entered pulses for each code digit.

FIG. 6 shows yet another alternate three position switch 210. Switch 210 is a single element rocker switch with an element 211 having a generally V-shaped cross section having a first end 212 and a second end 213. The first “closed” position is achieved by the user depressing first end 212 in the direction shown by arrow 215 to reach contact 216. The pulse is transmitted along line 217 to the counter 542. Ends 212 and 213 are spring loaded to return to the position shown in FIG. 6 which is the “open” position. The second “closed” position is achieved by the user depressing second end 213 until it reaches contact 220, causing a signal to be sent to the comparator 543 along the line 221. Element 211 pivots about its center 225 as in a conventional, commercially available rocker switch.

FIG. 7 shows another embodiment of the single element switch means wherein a rotary switch 310 is provided. A single rotational element 311 pivoted at point 312 may be rotated in a first clockwise direction shown by arrow 315 to a first “closed” position 316, at which point a pulse is sent through line 317 to the counter 542. The second “closed” position is achieved by rotating element 311 in a second or counterclockwise direction as shown in FIG. 7 in the direction of arrow 321 to second position 326 at which point a signal is sent on line 322 to comparator 543. The rotational element 311 is spring loaded to its center or “open” position shown in FIG. 7 between the first “closed” position and the second “closed” position. Element 311 returns to the “open” or center position when it is released by the user.

FIG. 8 shows a piezoelectric “tap and push” embodiment 410. In this embodiment, a piezoelectric element 411 is carried on the surface of a resiliently mounted button 412. Spring 415 is positioned between the base 413 of button 412 and the rear wall 421 of button housing 420. The first “closed” position is achieved by lightly tapping the surface of piezoelectric element 411. A pulse shaper and amplifier 416 generates a pulse in response to the light tapping and transmits the pulse on line 418 to counter 542. The second “closed” position is achieved by the user pressing piezoelectric element 411 with sufficient force to compress spring 415. When the base 413 reaches detent 422, the second “closed” position is achieved. In the second “closed” position, a signal is sent through line 429 to the comparator 543.

The various switch means described herein (i.e., rocker switch 10, push button switch 510, and switches 110, 210, 310 and 410) may also each be used as a start-stop switch for an engine or other operating mechanism. In other embodiments, such as for use with table saws, the start-stop switch for the mechanism is separate from switch means 10, 110, 210, 310, 410 and 510. In still further embodiments, the various switch means described herein are used to enable or disable a mechanism or to arm or disarm a mechanism.

It is to be understood that the single element keyless control system herein shown and described may be utilized in a wide variety of applications. In some of those applications, this system may be retrofitted into the mechanism as in an automobile ignition or door lock, for example. Variations may be made in the components described herein without departing from the spirit of the invention, such as using switches with more than three positions or having only two levels of security, or having no security and low level security. In one embodiment an annunciator is provided in addition to or in place of the LED indicators to “speak” the status of the system to a user Annunciator systems are well known in the art.

What is claimed is:

1. In a single element keyless control system for locking or unlocking or enabling or disabling a mechanism, wherein a user unlocks or enables the mechanism by manipulating a switch to enter a code, wherein the entered code is detected and compared to a stored access code having one or more digits, and upon entry of the access code, the mechanism is unlocked or enabled, the improvement comprising:
means for providing multiple levels of security, each higher security level being associated with an access code having more digits than the code associated with a lower level of security,
means for selecting a security level, the security level selected by the user determining the access code the user must input to enable the mechanism, and
a single element switch means having an “open” position and two “closed” positions, wherein the user enters a code digit by manipulating the switch means to one of the “closed” positions a number of times equal to the code digit and, if the access code has more than one digit, the user then manipulates the switch means to the other “closed” position a number of times to enter the next digit, and wherein the user then repeats the same steps for any remaining digits of the code.

2. The control system of claim 1 wherein the levels of security include, no security, low security and high security, the no security level allowing the user to unlock or enable the mechanism without inputting any access code.

3. The control system of claim 2 wherein a low security access code is a subset of a high security access code.

4. The control system of claim 3 further comprising feedback means for identifying each level of security selected.

5. The control system of claim 4 wherein the feedback means comprises a different colored light display for each different level of security selected.

6. The control system of claim 5 wherein the means for selecting a security level comprises manipulating the switch means by a user when the keyless control system is enabled.

7. The control system of claim 6 wherein:
a selected low or high security level is not enabled until after a predetermined waiting period; and
any input during the predetermined waiting period changes the security level and restarts the waiting period if the input changed the security level to a low or high security level.

8. The control system of claim 7 further comprising a light having a constant display when the low or high security level is selected until the predetermined amount of time elapses, after which the light blinks a preselected color, indicating the control system is armed with the selected level of security.

9. The control system of claim 1 further comprising means for powering down the system if the system has not received any user input for a predetermined amount of time, and for powering the system back up in response to an initial user input, the initial input not being detected as part of the access code.

10. The control system of claim 1 further comprising locking means for detecting any incorrect access code input by a user and locking out further access code input for a predetermined amount of time.

11. The control system of claim 10 further comprising a light which indicates when the predetermined amount of time has elapsed allowing further access code entry by the user.

12. The control system of claim 1 further comprising means for allowing the user to program the access codes for each level of security.

13. The control system of claim 1 further comprising means for programming multiple access codes for each level of security.

14. The control system of claim 1 wherein the access code must be reentered if the system receives no user input for a predetermined amount of time.

15. The control system of claim 1 wherein the switch means functions as a stop-start switch for the mechanism after an access code has successfully been entered to enable the mechanism.

16. A method for operating a keyless control system having an enabled state and a disabled state, the keyless control system including a momentary switch having an “open” rest position and two “closed” positions, the method including:
placing the keyless control system into an enabled state from a disabled state by entering a code including a preset plurality of code digits, alternately entering code digits by placing the switch in one of the “closed” positions a number of times equal to a code digit and, then placing the switch in the other “closed” position to enter another code digit;
setting a level of security to “no security” in response to the keyless control system being placed into an enabled state from a disabled state by entering a preset plurality of code digits;
enabling starting and stopping of a mechanism associated with the keyless control system while in the enabled state, wherein the mechanism is started in response to placing the switch in a first preselected one of the “closed” positions; and wherein the mechanism is stopped in response to placing the switch in a second preselected one of the “closed” positions; and
enabling selection of a level of security while in the enabled state, selection of a level of security implemented by manipulating the switch to the second preselected one of the “closed” positions when the mechanism associated with the keyless control system is in a stopped state.

17. The method of claim 16 further comprising:
detecting incorrect entry of a code; and
disabling further code entry for a preset period of time.

18. The method of claim 16 further including:
sensing that the switch has been placed in the second preselected one of the “closed” positions when the mechanism associated with the keyless control system is in the enabled state; and
toggling the keyless control system between levels of security in response to the sensing.

19. The method of claim 16 further including:
sensing that the switch has been placed in the first preselected one of the “closed” positions when the keyless control system is in the enabled state and the mechanism associated with the keyless control system is in a stopped state; and
starting the mechanism associated with the keyless control system in response.

20. The method of claim 16 further including:
sensing that the switch has been placed in the second preselected one of the “closed” positions when the keyless control system is in the enabled state and the mechanism associated with the keyless control system is running; and
stopping the mechanism associated with the keyless control system in response.
